(19) United States
(12) Patent Application Publication
(10) Pub. No.: US 2012/0022908 A1
(43) Pub. Date: Jan. 26, 2012

(54) TERRITORY MANAGEMENT SYSTEM AND METHOD

(76) Inventors: Thomas Sprimont, Irvine, CA (US); Daryl Dressel, Irvine, CA (US)

(21) Appl. No.: 12/842,321

(22) Filed: Jul. 23, 2010

(51) Int. Cl. G06Q 10/00

(52) U.S. Cl. 705/7.16

(57) ABSTRACT

An apparatus manages delivery of services by service technicians to a plurality of assets within a plurality of user defined territories. The apparatus includes a service territory selector selecting a plurality of service territories, and a geo-code data retrieval portion configured to retrieve for each of first and second sets of assets associated with respective first and second territories, asset data including geocode data representative of geographic locations of each of the assets of the first and second sets of assets. A constraint selector stores constraint parameter data representative of user selected constraints, and a threshold data selector stores threshold parameter data representative of user selected thresholds. A constraint processor applies the constraint parameter data to the asset data, a comparator determines a comparison between the asset data constrained by the constraint parameter data relative to the threshold parameter data, and a display displays a result of the comparison.

### BACKGROUND

The subject example embodiments are directed to art of business management systems, and are particularly adapted to customer service management systems and methods. The subject example embodiments find use in the managing of targets of customers to be serviced by personnel within territories for example, wherein the targets and customers may change from time to time and wherein the demand for type and level of servicing of the targets and customers may change as well. It will be appreciated that the systems and methods are particularly advantageous in connection with the managing of physical assets such as printing equipment or other various machines or the like within territories by service technicians assigned to those territories. However, the embodiments are suited for use in any application of managing the time and focus of the efforts of a workforce on items and any other assets grouped into territories.

The support of products such as, for example machines in the field in service at customer sites requires a workforce of technicians to perform regular maintenance, and to respond to problems and other issues arising with the machines during contract or warranty periods. In many cases, although customer level service agreements must be maintained in accordance with the one or more contracts with the customers, difficulties may arise making fulfillment of those obligations difficult or impossible. One difficulty is the diminished visibility of the technician group over the service contract area owing in part to dynamic nature of the workloads of the technicians across their respective territories. The diminished visibility is also influenced by changes made to the assignments of technicians to customers or machines in the field. Still further, irrespective of changes in workloads, assignments and service contract areas, the travel time of the technicians and the actual hands-on repair times of physical or other assets for example can vary widely between different service fulfillment activities.

These difficulties often lead to over-staffing or under-staffing the territories, and, ultimately, to increased costs which may result in an inability to properly size the service business relative to the contract obligations and deterioration in customer service key performance indicators. The underlying or root-cause problem is essentially the inability to timely assess and then to quickly assign the required workforce for changing machines in the field. If unattended, this could lead to inadequate coverage for certain areas, over coverage in other areas, and potential missed commitments contained in service level agreements.

To address the above, some service managers have attempted to periodically realign the territories under their control relative to the available workforce. Current methods range from manually arranging colored push-pins on a geographical map representing service personnel within service territories, to manipulating spreadsheets to rearrange selected staffing relative to the changing needs of the machines in the territories. However, this is imprecise and managers often do not have adequate time to make the necessary adjustments and they often lack updated information. Consequently, there is a tendency to over-staff the territories to ensure that the needs of the customers in the territories are fully met. This leads to a higher cost structure because the workforce committed to cover the territories exceeds the required demand or need.

### SUMMARY

The subject embodiments teach systems and methods for territory management. In accordance with an example embodiment, a territory management method is provided. The method is executed by a territory management system including a processor, a memory, and a display for managing delivery of services by a plurality of service technicians to a plurality of assets within a plurality of user defined territories. The method includes steps of selecting a plurality of service territories; retrieving for each of a first set of assets associated with the first territory and a second set of assets associated with the second territory, asset data including geocode data representative of geographic locations of each of the assets of the first and second sets of assets; storing constraint parameter data representative of user selected constraints in the memory; storing threshold parameter data representative of user selected thresholds in the memory; applying by the processor the constraint parameter data to the asset data; determining by the processor a comparison between the asset data constrained by the constraint parameter data relative to the threshold parameter data; and, displaying on the display a result of the comparison.

### BRIEF SUMMARY OF THE DRAWINGS

The example embodiments will be described in connection with a series of drawings which are provided for illustrating the preferred and alternative embodiments only, and not for the purpose of limiting same, wherein:

FIG. 1 is a simplified block diagram of a territory management system in accordance with an example embodiment;

FIG. 2 is a hardware block diagram of a workstation of FIG. 1;

FIG. 3 is a hardware block diagram of a representative asset in the system of FIG. 1;

FIG. 4 is a functional block diagram of the representative asset of FIG. 3;

FIG. 5 is a flow chart of a territory management method in accordance with an example embodiment;

FIG. 6 is a functional block diagram of a territory management system in accordance with the example embodiment of FIG. 5;

FIG. 7a is a view of example results presented on a display of the system to a user during manual territory selection of FIG. 5;

FIG. 7b is a view of example results presented on a display of the system to a user during an adjusted manual territory selection of FIG. 5;

FIG. 8 is a flow chart of a territory management method in accordance with a further example embodiment;

FIG. 9 is a functional block diagram of a territory management system in accordance with the example embodiment of FIG. 8;

FIG. 10 is a workflow diagram of the automated territory adjustment portion of the territory management method of FIG. 2;

FIG. 11a is a graphical illustration of the automated territory adjustment method showing the general manner of optimization of FIG. 10 simplified to a pair of territories; and,

FIG. 11a is a graphical illustration of the automated territory adjustment method showing example results of optimization applied to the simplified pair of territories of FIG. 11a.

### DETAILED DESCRIPTION OF THE PREFERRED EMBODIMENTS

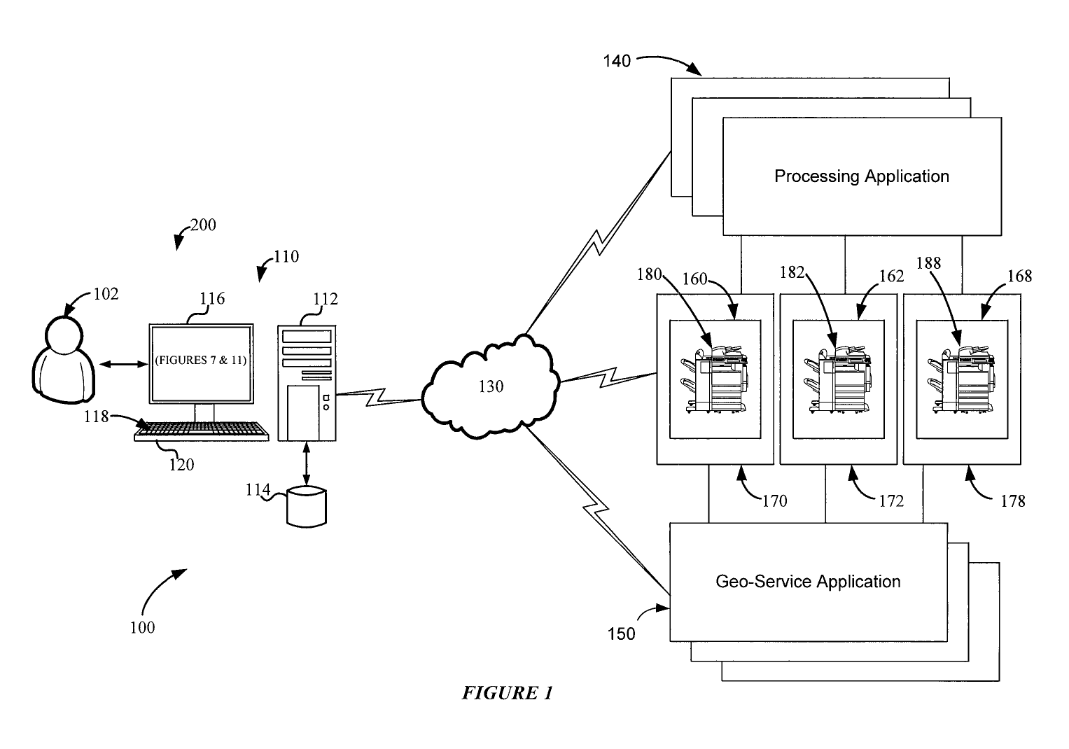

Turning now to the drawings, wherein the depictions are for the purpose of showing the example and alternate embodiments only, and not for the purpose of limiting the same, FIG. 1 illustrates a territory management system 100 that includes a user terminal 110 in the form of a workstation 200 for use by an associated user 102 and including a processor 112, a memory 114 operatively coupled with the processor 112, a human readable display 116 configured to selectively present data and images of territories or the like to the user 102, and a human interface device 118 shown in the example embodiment as a keyboard 120. The user terminal 110 is operatively coupled with an associated network 130 which may take on any form including for a example wired or wireless network, a local area network (LAN), a wide area network (WAN) or the internet. Using the network 130, the user terminal 110 is further operatively coupled with one or more processing application systems 140 and with one or more geo-service application systems 150. As will be described in greater detail below, the one or more application systems 140 are configured to operatively interact with and to be responsive to the user terminal 110 and other user terminals (not shown) for processing data on behalf of the user terminal 110 and the other user terminals in accordance with selected processing structures, techniques and algorithms. The one or more application systems 140 are further operative with the one or more geo-service applications systems 150 for determining geo-location data of the assets in the service field.

In the example embodiment illustrated, the one or more application systems 140 are in operative communication with asset sets 160, 162, 164, 166, 168. Further in the example embodiment, the one or more geo-service application systems 150 are similarly in operative communication with the asset sets 160, 162, 164, 166, 168 disposed in corresponding territories 170, 172, 174, 176, 178. Each asset set typically includes one or more physical devices 180, 182, 184, 186, 188 disposed in the territories 170, 172, 174, 176, 178. Each asset is configured to generate service related data representative of device performance characteristics such as volume production, service intervals, service downtime, and the like, and geo-code data representative of a geographical location of the asset. The one or more application systems 140 are configured for receiving the service related data from each of the devices of the asset sets and for processing the data in accordance with procedures set out in greater detail below. The service related data is updated at predetermined or selectable intervals or as necessary such as in accordance with maintenance schedules, machine use or malfunction or the like. Correspondingly, the geo-service application system 150 is configured for receiving the geo-code data from each of the devices of the asset sets representative of geographic locations of each of the assets. In one preferred form, the geo-code data are address locations of the assets rendered into codes recognizable by geographical application programs such as mapping application programs executed by the geo-service application system 150. One example mapping application program of the application system 150 is MapQuest available from Google, although other mapping application programs can be used equivalently. In the example embodiment, the geocode data is updated at predetermined or selectable intervals or as necessary such as when the asset is moved or otherwise relocated for example, wherein the updated data may be stored in a database in the memory 114 of the user terminal 110.

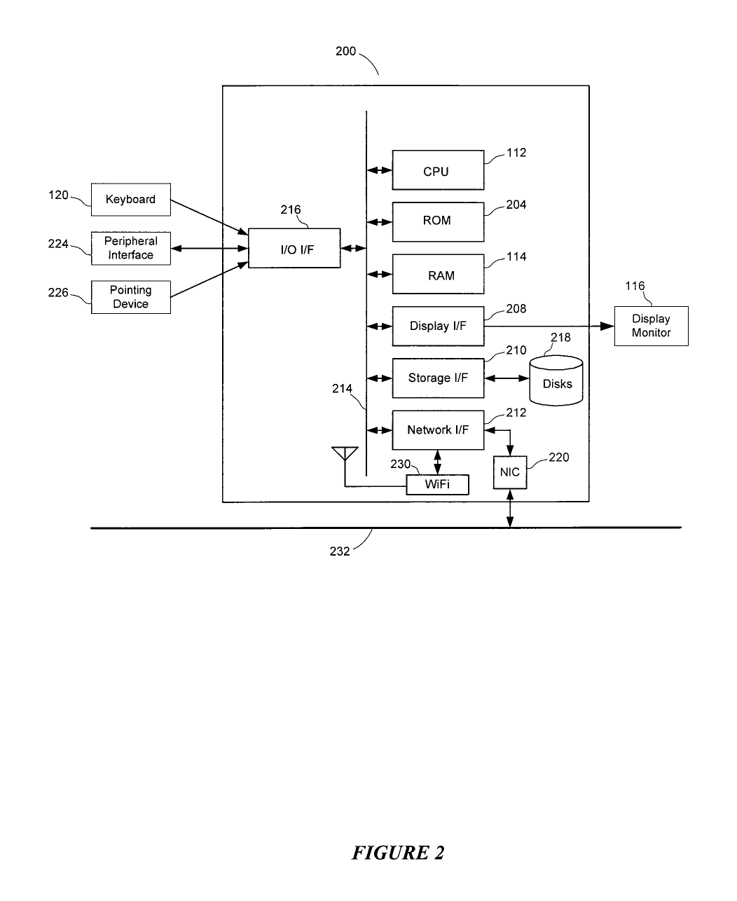

Turning now to FIG. 2, illustrated is a hardware diagram of a suitable workstation 200 for use in connection with the subject system. A suitable workstation includes a processor unit 112 which is advantageously placed in data communication with read only memory 204, suitably non-volatile read only memory, volatile read only memory or a combination thereof, random access memory 114, display interface 208, storage interface 210, and network interface 212. In a preferred embodiment, interface to the foregoing modules is suitably accomplished via a bus 214.

The read only memory 204 suitably includes firmware, such as static data or fixed instructions, such as BIOS, system functions, configuration data, and other routines used for operation of the workstation 200 via CPU 112.

The random access memory 114 provides a storage area for data and instructions associated with applications and data handling accomplished by the processor 112.

The display interface 208 receives data or instructions from other components on the bus 214, which data is specific to generating a display to facilitate a user interface. The display interface 208 suitably provides output to a display terminal 116, suitably a video display device such as a monitor, LCD, plasma, or any other suitable visual output device as will be appreciated by one of ordinary skill in the art.

The storage interface 210 suitably provides a mechanism for non-volatile, bulk or long term storage of data or instructions in the workstation 200. The storage interface 210 suitably uses a storage mechanism, such as storage 218, suitably comprised of a disk, tape, CD, DVD, or other relatively higher capacity addressable or serial storage medium.

The network interface 212 suitably communicates to at least one other network interface, shown as network interface 220, such as a network interface card, and wireless network interface 230, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system. In the illustration, the network interface 220 is interconnected for data interchange via a physical network 232, suitably comprised of a local area network, wide area network, or a combination thereof.

An input/output interface 216 in data communication with the bus 214 is suitably connected with an input device such as a keyboard 120 or the like. The input/output interface 216 also suitably provides data output to a peripheral interface 224, such as a USB, universal serial bus output, SCSI, Firewire (IEEE 1394) output, or any other interface as may be appropriate for a selected application. Finally, the input/output interface 216 is suitably in data communication with a pointing device interface 226 for connection with devices, such as a mouse, light pen, touch screen, or the like.

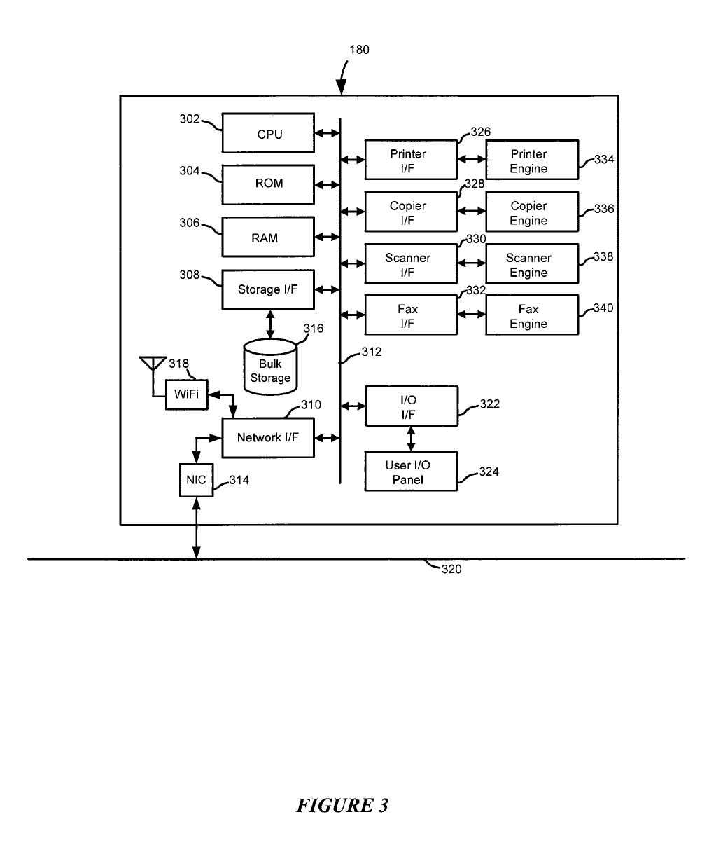

Turning now to FIG. 3, illustrated is a representative architecture of a representative asset 180, 182 . . . 188 upon which the subject system is focused. Included is a processor 302, suitably comprised of a central processor unit. However, it will be appreciated that the processor 302 may advantageously be composed of multiple processors working in concert with one another as will be appreciated by one of ordinary skill in the art. Also included is a non-volatile or read only memory 304 which is advantageously used for static or fixed data or instructions, such as BIOS functions, system functions, system configuration data, and other routines or data used for operation of the device 160.

Also included in the device 180 is random access memory 306, suitably formed of dynamic random access memory, static random access memory, or any other suitable, addressable memory system. Random access memory provides a storage area for data instructions associated with applications and data handling accomplished by the processor 302.

A storage interface 308 suitably provides a mechanism for volatile, bulk or long term storage of data associated with the device 180. The storage interface 308 suitably uses bulk storage, such as any suitable addressable or serial storage, such as a disk, optical, tape drive and the like as shown as 316, as well as any suitable storage medium as will be appreciated by one of ordinary skill in the art.

A network interface subsystem 310 suitably routes input and output from an associated network allowing the device 180 to communicate to other devices. The network interface subsystem 310 suitably interfaces with one or more connections with external devices to the device 180. By way of example, illustrated is at least one network interface card 314 for data communication with fixed or wired networks, such as Ethernet, token ring, and the like, and a wireless interface 318, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 314 is interconnected for data interchange via a physical network 320, suitably comprised of a local area network, wide area network, or a combination thereof.

Data communication between the processor 302, read only memory 304, random access memory 306, storage interface 308 and the network subsystem 310 is suitably accomplished via a bus data transfer mechanism, such as illustrated by bus 312.

Suitable executable instructions on the device 180 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 322 to a user input/output panel 324 as will be appreciated by one of ordinary skill in the art.

Also in data communication with the bus 312 are interfaces to one or more document processing engines. In the illustrated embodiment, printer interface 326, copier interface 328, scanner interface 330, and facsimile interface 332 facilitate communication with printer engine 334, copier engine 336, scanner engine 238, and facsimile engine 340, respectively. It is to be appreciated that the device 180 suitably accomplishes one or more document processing functions. Systems accomplishing more than one document processing operation are commonly referred to as multifunction peripherals or multifunction devices.

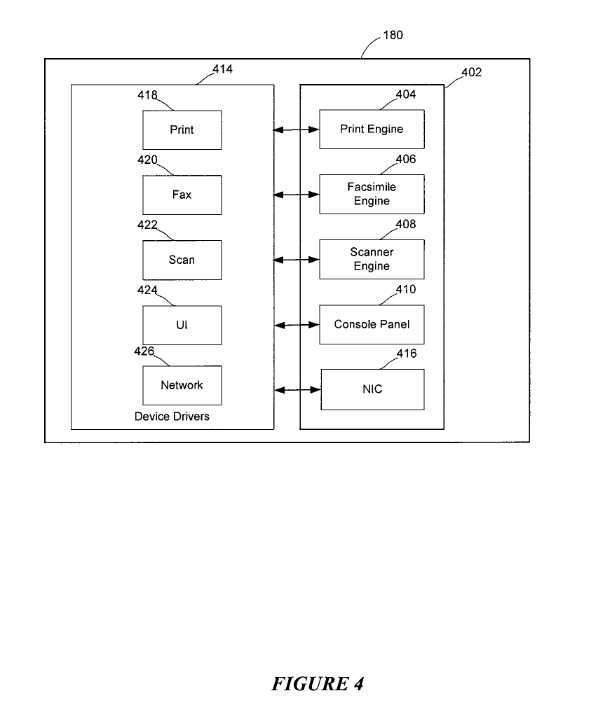

FIG. 4 illustrates suitable functionality of the hardware of the example asset shown in FIG. 3 in connection with software and operating system functionality as will be appreciated by one of ordinary skill in the art. The document processing device 180 suitably includes an engine 402 which facilitates one or more document processing operations.

The document processing engine 402 suitably includes a print engine 404, facsimile engine 406, scanner engine 408 and console panel 410. The print engine 404 allows for output of physical documents representative of an electronic document communicated to the processing device 180. The facsimile engine 406 suitably communicates to or from external facsimile devices via a device, such as a fax modem.

The scanner engine 408 suitably functions to receive hard copy documents and in turn image data corresponding thereto. A suitable user interface, such as the console panel 410, suitably allows for input of instructions and display of information to an associated user. It will be appreciated that the scanner engine 408 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 4, the document processing engine also comprises an interface 416 with a network via driver 426, suitably comprised of a network interface card. It will be appreciated that a network thoroughly accomplishes that interchange via any suitable physical and non-physical layer, such as wired, wireless, or optical data communication.

The document processing engine 402 is suitably in data communication with one or more device drivers 414, which device drivers allow for data interchange from the document processing engine 402 to one or more physical devices to accomplish the actual document processing operations. Such document processing operations include one or more of printing via driver 418, facsimile communication via driver 420, scanning via driver 422 and a user interface functions via driver 424. It will be appreciated that these various devices are integrated with one or more corresponding engines associated with the document processing engine 402. It is to be appreciated that any set or subset of document processing operations are contemplated herein.

Document processors which include a plurality of available document processing options are referred to as multi-function peripherals.

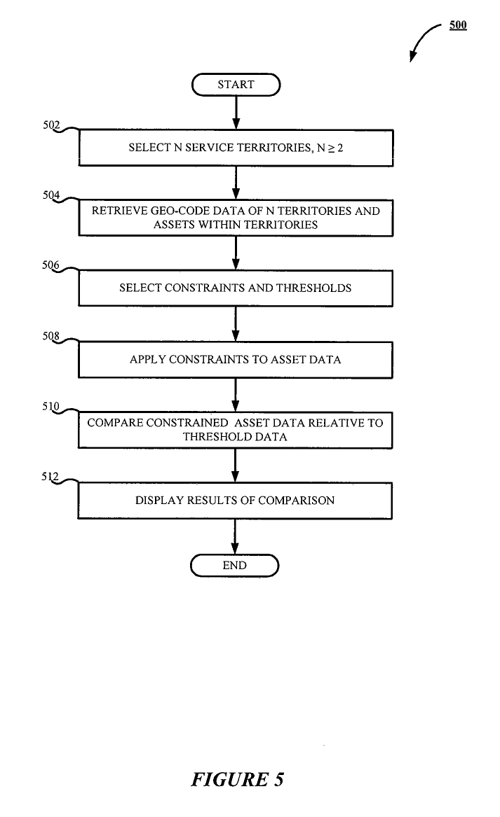

FIG. 5 is a simplified flow chart of a territory management method 500 in accordance with an example embodiment. The method enables users 102 such as service managers for example to use the system 100 of FIG. 1 to use real time asset and service data to optimize the territories relative to the assets ultimately improving the efficiency and effectiveness of the work force deployment in those territories. Using the display 116 of the system 110 the service manager may select at 502 the virtual boundaries of N territories, where N is an integer greater than or equal to 2, thus selecting two or more territories. For example, the user may draw a closed rectangular area as a territory on the display 116 encircling one or more assets within each of the two or more virtual territories. Geo-code data is retrieved at 504 relative to the selected virtual boundaries of two or more territories such as for example from the geo-service application system 150 and stored in the memory 114 together with the geo-code data of the assets 180, 182, 184, 186, 188 among the asset sets 160, 162, 164, 166, 168 within the territories 180, 182, 184, 186, 188. The geo-code data of the territory boundaries and of the assets may be stored in the memory 114 including storage in a database in the memory for manipulation by one or more database application programs executable by the system as necessary or desired.

At 506 the user may select from a set of constraint parameters for application by the system against the assets relative to the territories at 508. The constraints may include, for example, parameters such as a ZIP code of the assets, call activity time (CAT), and other limitations or information as may be deemed necessary for performing the territory management. The constraint parameters may be used, for example, to filter the data of the assets within or among the relevant territories, thereby enabling a more efficient application of the processing by the system 150.

At 506 the user may further enter threshold data wherein the threshold data may include a maximum service drive time parameter, a maximum service drive distance parameter, a maximum asset count per territory parameter value or any other threshold parameter or metric as desired. The constraints are applied to the asset data at 508 and the filtered results are compared against the threshold data at 510. The comparison and results are presented at 512 to the user 102 on the display 116 of the system 110 in the form of a baseline service territory analysis relative to the one of more threshold parameters.

A user unhappy with the results presented at 512 may perform a further manual territory adjustment procedure 500 wherein the virtual boundaries initially selected at 502 may be manually adjusted on the display by the user by simply repeating the select service territory step 502, but using new territory boundaries. For example, if the aggregate call activity time for the selected virtual territory exceeds the threshold maximum CAT, the user may want to adjust the territory to reduce the number of assets within the territory such as for example by downwardly resizing the virtual territory or by allocating a portion of a first territory to a second territory.

Steps 504-512 are then again followed for presentation of new results based on the new territories for review by the user.

Users who remain unhappy with the results presented at 512 after repeated manual attempts may wish invoke an automatic territory adjustment procedure wherein the virtual boundaries initially selected at 502 may be automatically adjusted by the system 100 based on an automatic territory adjustment protocol to be described in greater detail below. Similar to the manual adjustment described above, the automatic territory adjustment procedure presents the new results based on the new territories for review by the user.

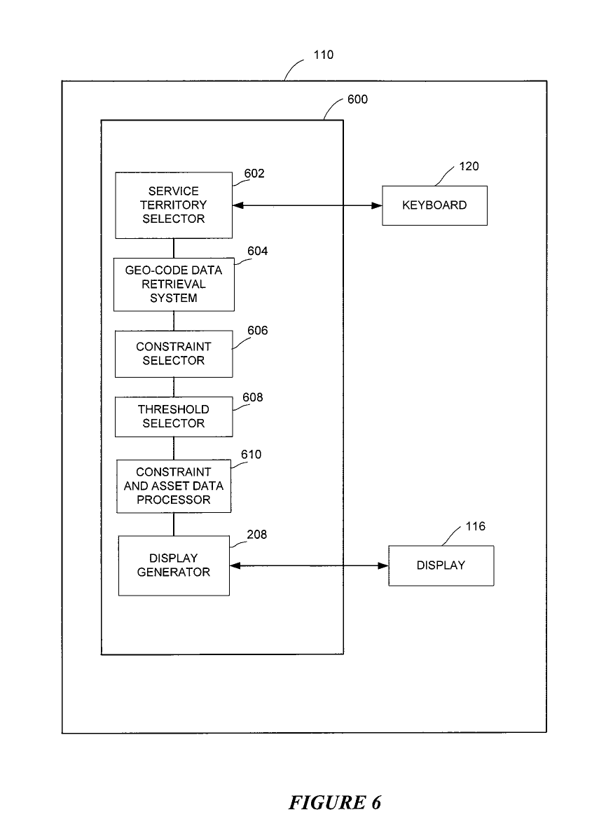

FIG. 6 is a functional block diagram of a territory management system 600 configured to perform in the workstation 110 the territory management method in accordance with the example embodiment of FIG. 5. The system 600 enables users 102 such as service managers for example to use the system 100 of FIG. 1 to use real time asset and service data to optimize the territories relative to the assets ultimately improving the efficiency and effectiveness of the work force deployment in those territories. Using the display 116 and the keyboard 120 of the system 110, a service territory selector 602 enables the service manager to select the virtual boundaries of one or more territories 170, 172, 174, 176, 178. For example, the user may draw a closed rectangular area as a territory on the display 116 encircling one or more assets within the virtual territory. Using a geo-code retrieval system portion 604, geo-code data is retrieved relative to the selected virtual boundaries of one or more territories such as for example from the geo-service application system 150 and stored in the memory 114 together with the geo-code data of the assets 180, 182, 184, 186, 188 among the asset sets 160, 162, 164, 166, 168 within the territories 180, 182, 184, 186, 188. The geo-code data of the territory boundaries and of the assets may be stored in the memory 114 including storage in a database in the memory for manipulation by one or more database application programs executable by the system as necessary or desired.

A constraint selector 606 enables the user to select from a set of constraint parameters for application by the system against the assets relative to the two or more territories. The constraints may include, for example, parameters such as a ZIP code of the assets, call activity time (CAT), and other limitations or information as may be deemed necessary for performing the territory management. The constraint parameters may be used, for example, to filter the data of the assets within or among the relevant territories, thereby enabling a more efficient application of the processing by the system 150.

A threshold data selector 608 enables the user to enter or other wise select threshold data wherein the threshold data may include a maximum service drive time parameter, a maximum service drive distance parameter, a maximum asset count per territory parameter value or any other threshold parameter or metric as desired. The constraints are applied to the asset data by a constraint and asset data processor portion 610 of the territory management system 600 and the filtered results are compared against the threshold data by the processor 610. The comparison and results are formatted and generated into a suitable format by the display generator 208 for presentation to the user 102 on the display 116 of the system 110 in the form of a baseline service territory analysis relative to the one of more threshold parameters.

A user unhappy with the results presented may perform a further manual territory adjustment procedure using the system 600 wherein the virtual boundaries initially selected using the service territory selector 602 may be manually adjusted on the display by the user by simply repeating the select service territory step 502 (FIG. 5), but using new territory boundaries provided to the service territory selector 602. For example, if the aggregate call activity time for the selected virtual territory exceeds the threshold maximum CAT, the user may want to adjust the territory to reduce the number of assets within the territory such as for example by downwardly resizing the virtual territory or by allocating a portion of a first territory to a second territory.

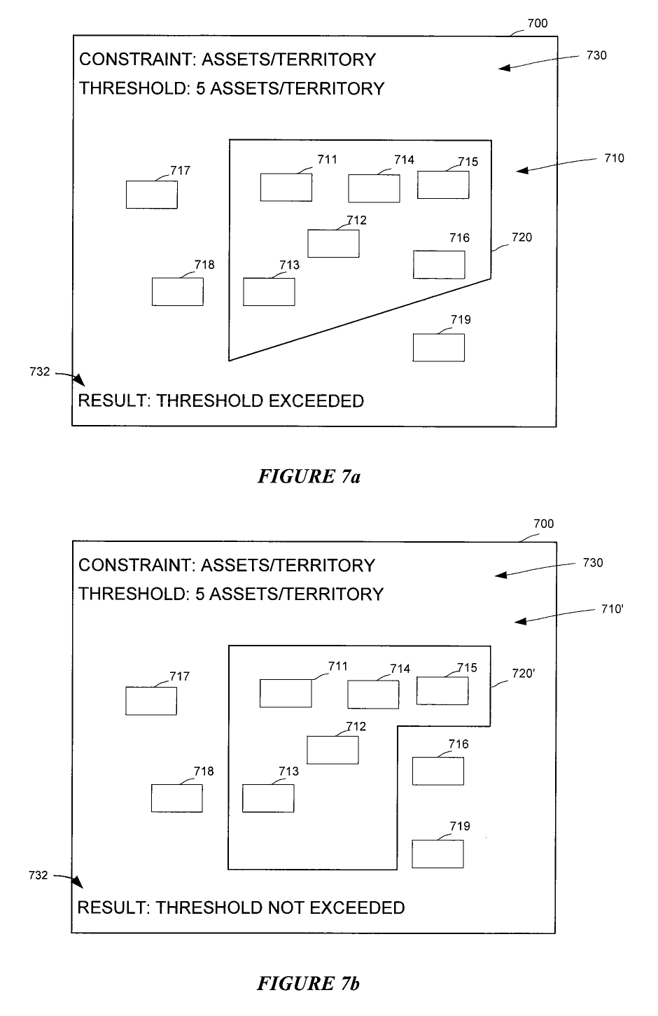

FIG. 7a is a simplified illustration of a display screen 700 presented to the user 102 on the user terminal 110 showing a finite set of assets 710 within a virtual territory 720 bounded by a closed virtual box 720 in the general form of a parallelogram. It is to be understood, however, at the user may designate a virtual territory 720 of any form or shape and the straight line segments of the illustrated virtual boundary 720 is for illustration only. The first set of assets 310 in the example include a set of six (6) individual assets 711-716, but do not include the set of three (3) outlier individual assets 717-719. The outlier assets 717-719 are not within the virtual territory 720 drawn on the display 116 by the user bounded by the closed virtual box 722. With continued reference to the display screen 700 of FIG. 7a, the user may select the number of assets per territory at step 506 of the method of FIG. 5 and a threshold of five (5) assets per territory at step 508 of the method of FIG. 5. It is to be appreciated that the number of assets per territory is only an example of a constraint and not the only constraint available for selection by the user. Similarly, it is to be appreciated that five (5) assets per territory is only an example of a threshold data value and not the only threshold available for selection by the user.

In any case, the user selectable data items are shown in a selection area 730 of the display screen 700. Since the actual number of assets 711-776 within the user-selected virtual territory 720 exceeds the threshold value, the result of a threshold exceeded is presented to the user on a results area 732 of the display screen 700.

FIG. 7b is a simplified illustration of the display screen 700 of FIG. 7a presented to the user 102 on the terminal 110 after the user executes the selection of a manual territory adjustment in accordance with repeating the steps 502-512 of the method 500 of FIG. 5 and after new manual territory selection 502. As shown, a second set of assets 710′ within the adjusted virtual territory 720′ are bounded by an adjusted virtual box 722′ in the general form of an L-shaped form selected by the user at step 502. The second set of assets 710′ contained within the adjusted virtual territory 720′ include the set of five (5) assets 711-715, but does not include the set of four (4) assets 716-719. The asset 716 was formerly within the initial virtual territory 720 (FIG. 7a) but is an outlier asset in the adjusted virtual territory 720′ (FIG. 7b).

With continued reference to the display screen 700 of FIG. 7b, the user has formerly selected the number of assets per territory at step 506 of the method of FIG. 5 and a threshold of five (5) assets per territory at step 508 of the method of FIG. 5. The user selectable data items are shown in a selection area 730 of the display screen 700. Since the actual number of assets 711-716 within the user-selected adjusted virtual territory 720′ is within the threshold value, the result of a threshold exceeded is presented to the user on a results area 732 of the display screen 700. In the above description, it is to be appreciated that the constraint of number of assets per territory is merely an example and other criteria and constraints may be used as well including for example travel time, technician skill set or specialty, call activity time, and any other metric as deemed necessary or desired.

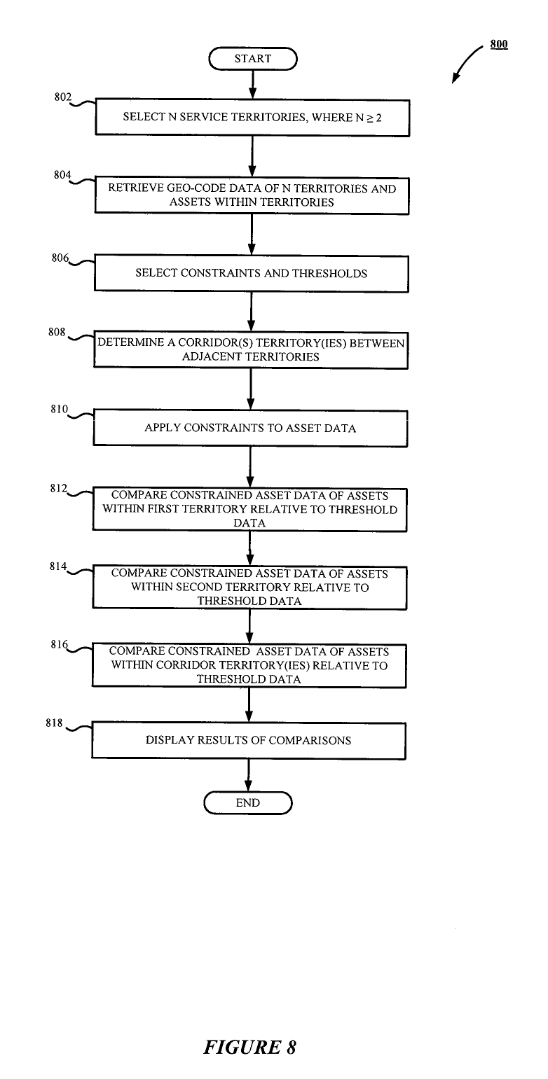

FIG. 8 is a simplified flow chart of an automatic territory management method 800 in accordance with an example embodiment. The method enables users 102 such as service managers for example to use the system 100 of FIG. 1 to use real time asset and service data to optimize the territories relative to the assets ultimately improving the efficiency and effectiveness of the work force deployment in those territories. A corridor territory between adjacent first and second territories is created automatically by the system and assets located within the corridor are selectively reassigned to a one of the first or second territories in order to balance the overall territory managed by the system. For more complex areas, a plurality of two (2) or more adjacent territories are analyzed by the system simultaneously and automatically. Using the display 116 of the system 110 the service manager may select at 802 the virtual boundaries of N territories, where N is an integer greater than or equal to two (2). For example, the user may draw a closed rectangular area as a territory on the display 116 encircling one or more assets within the virtual territory. Geo-code data is retrieved at 804 relative to the selected virtual boundaries of the N territories such as for example from the geo-service application system 150 and stored in the memory 114 together with the geo-code data of the assets 180, 182, 184, 186, 188 among the asset sets 160, 162, 164, 166, 168 within the territories 180, 182, 184, 186, 188. The geo-code data of the territory boundaries and of the assets may be stored in the memory 114 including storage in a database in the memory for manipulation by one or more database application programs executable by the system as necessary or desired.

At 806 the user may select from a set of constraint parameters for application by the system against the assets relative to the territories at 810. The constraints may include, for example, parameters such as a ZIP code of the assets, call activity time (CAT), and other limitations or information as may be deemed necessary for performing the territory management.

The constraint parameters may be used, for example, to filter the data of the assets within or among the relevant territories, thereby enabling a more efficient application of the processing by the system 150.

At 806 the user may further enter threshold data wherein the threshold data may include a maximum service drive time parameter, a maximum service drive distance parameter, a maximum asset count per territory parameter value or any other threshold parameter or metric as desired.

After the user selects the one or more territories at 802, the system automatically determines at 808 one or more corridor areas or territories between adjacent territories. The constraints are applied to the asset data at 810 and the filtered results are compared against the threshold data at 812-816. At 812 the data of the assets within the first territory filtered by the constraint data are compared against the threshold data. At 814 the data of the assets within the second territory filtered by the constraint data are compared against the threshold data. Similarly, at 816 the data of the assets within the corridor territory filtered by the constraint data are compared against the threshold data. The comparison and results are presented at 818 to the user 102 on the display 116 of the system 110 in the form of a baseline service territory analysis relative to the one of more threshold parameters. Recommendations for the reassignment of assets located within the corridor area are made by the system in accordance with the results of the constraint filtering and threshold application. A user unhappy with the results presented at 818 may perform a further manual territory adjustment procedure 500 (FIG. 5) wherein the virtual boundaries initially selected at 802 may be manually adjusted on the display by the user by simply repeating the select service territory step 802, but using new territory boundaries. For example, if the aggregate call activity time for the selected virtual territory exceeds the threshold maximum CAT, the user may want to adjust the territory to reduce the number of assets within the territory such as for example by downwardly resizing the virtual territory or by allocating a portion of a first territory to a second territory.

Steps 802-816 are then again followed for presentation of new results based on the new territories for review by the user.

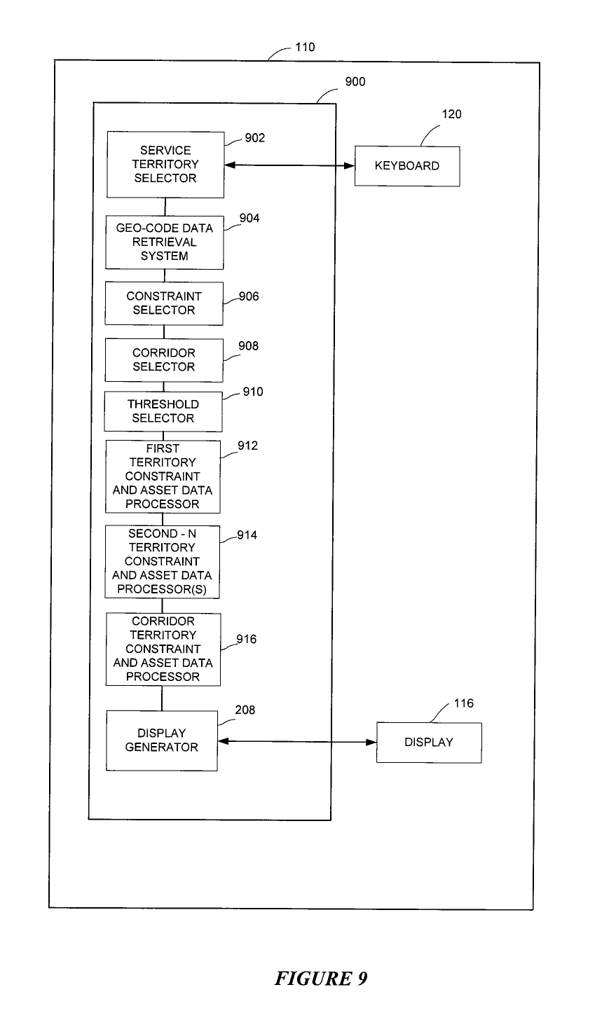

FIG. 9 is a functional block diagram of a territory management system 900 configured to perform in the workstation 110 the territory management method in accordance with the example embodiment of FIG. 8. The system 900 enables users 102 such as service managers for example to use the system 100 of FIG. 1 to use real time asset and service data to optimize the territories relative to the assets ultimately improving the efficiency and effectiveness of the work force deployment in those territories. Using the display 116 and the keyboard 120 of the system 110, a service territory selector 902 enables the service manager to select the virtual boundaries of one or more territories 170, 172, 174, 176, 178. For example, the user may draw a closed rectangular area as a territory on the display 116 encircling one or more assets within the virtual territory. Using a geo-code retrieval system portion 904, geo-code data is retrieved relative to the selected virtual boundaries of one or more territories including the corridor territory such as for example from the geo-service application system 150 and stored in the memory 114 together with the geo-code data of the assets 180, 182, 184, 186, 188 among the asset sets 160, 162, 164, 166, 168 within the territories 180, 182, 184, 186, 188. The geo-code data of the territory boundaries and of the assets may be stored in the memory 114 including storage in a database in the memory for manipulation by one or more database application programs executable by the system as necessary or desired.

A constraint selector 906 enables the user to select from a set of constraint parameters for application by the system against the assets relative to the two or more territories. The constraints may include, for example, parameters such as a ZIP code of the assets, call activity time (CAT), and other limitations or information as may be deemed necessary for performing the territory management. The constraint parameters may be used, for example, to filter the data of the assets within or among the relevant territories, thereby enabling a more efficient application of the processing by the system 150.

A corridor selector 908 of the system selects or otherwise defines corridor areas between adjacent territories selected by the service territory selector 902. The user may override the automatic corridor area selection or may provide parameters used by the system in establishing the corridor. For example, the user may designate a width of the corridor in terms of drive time for service technicians.

A threshold data selector 910 enables the user to enter or other wise select threshold data wherein the threshold data may include a maximum service drive time parameter, a maximum service drive distance parameter, a maximum asset count per territory parameter value or any other threshold parameter or metric as desired. The constraints are applied to the asset data of the assets located in the first territory by a constraint and asset data processor portion 912 of the territory management system 900 and the filtered results are compared against the threshold data by the processor 912. Further, the constraints are applied to the asset data of the assets located in the second-N territories by a constraint and asset data processor(s) portion 914 of the territory management system 900 and the filtered results are compared against the threshold data by the processor 914. Similarly, the constraints are applied to the asset data of the assets located in the corridor territory by a constraint and asset data processor portion 916 of the territory management system 900 and the filtered results are compared against the threshold data by the processor 916.

The comparison and results are formatted and generated into a suitable format by the display generator 208 for presentation to the user 102 on the display 116 of the system 110 in the form of a baseline service territory analysis relative to the one of more threshold parameters.

A user unhappy with the results presented may perform a further manual territory adjustment procedure using the system 900 wherein the virtual boundaries initially selected using the service territory selector 902 may be manually adjusted on the display by the user by simply repeating the select service territory step 902, but using new territory boundaries provided to the service territory selector 902. For example, if the aggregate call activity time for the selected virtual territory exceeds the threshold maximum CAT, the user may want to adjust the territory to reduce the number of assets within the territory such as for example by downwardly resizing the virtual territory or by allocating a portion of a first territory to a second territory.

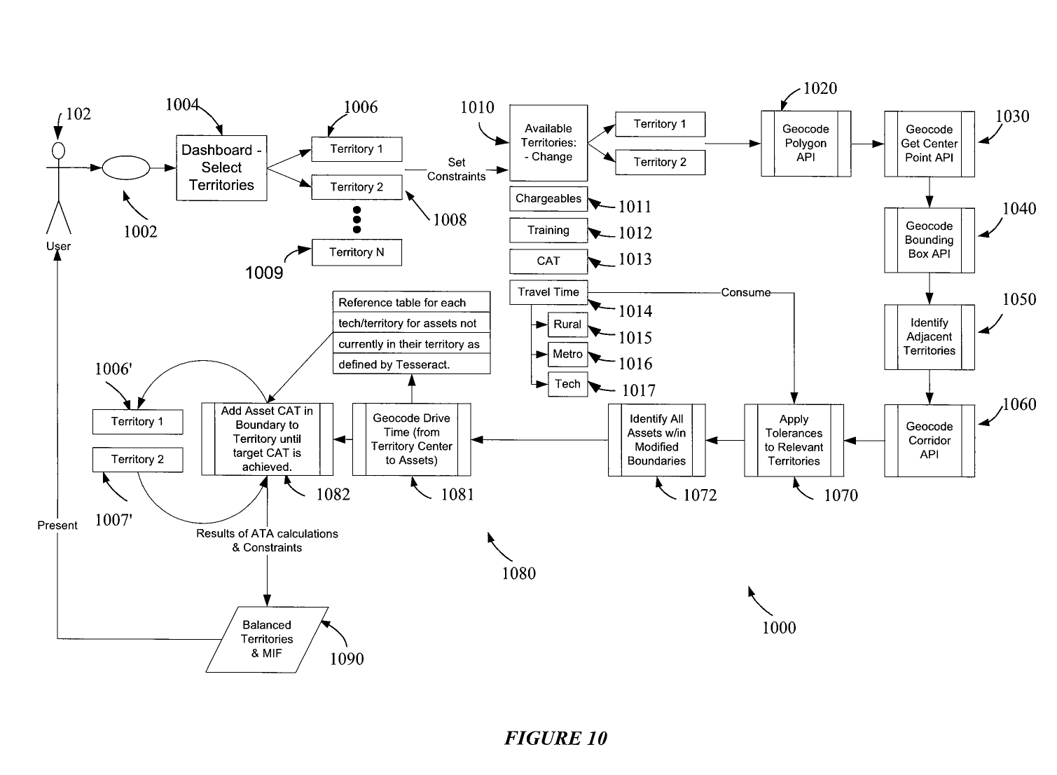

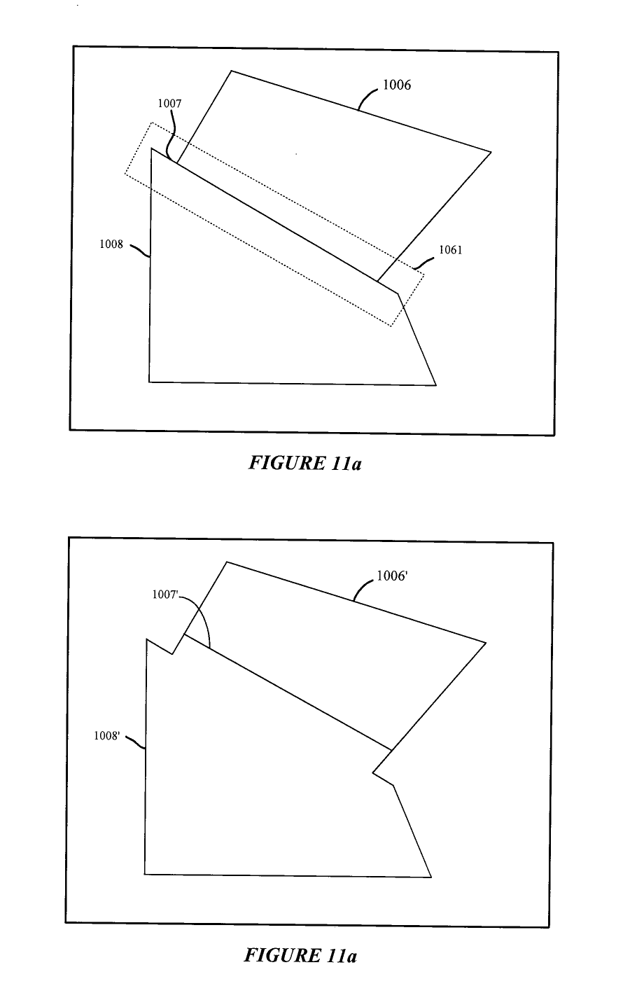

FIG. 10 is a workflow diagram 1000 illustrating data flow and work processing steps of the automated territory adjustment 800 of the methods for FIG. 8 and including a suggestion by the system of an automated territory alignment solution included with the display at step 818 thereof. Referring now to that Figure and with addition reference to FIGS. 11a and 11b, the user 102 provides the system 1000 with login credentials at 1002 and, if authorized by the system for territory alignment, the user is presented 1004 on the terminal 100 with a territory selection dashboard. The user may select from a plurality of virtual territories including for example a first virtual territory 1006, a second virtual territory 1008, and an N^{th} territory 1009 such as shown, for example, in FIG. 10. In the example embodiment, the user selects only two (2) virtual territories 1006 and 1008 such as shown, for example, in FIG. 11a. However, it is to be understood that many territories (more than two in the example) may be simultaneously selected for automated territory adjustment in accordance with the embodiments.

At 1010 the user may provide the system 1000 with a set of constraints for virtual territory alignment. Available constraints include, for example, chargeables included/excluded 1011, and training on/off 1012. Chargeables allow the user to include or exclude items chargeable to the customer for example. With regard to the training constraint, if training is set to on, then the system 1000 is instructed to not assign an asset to a technician who is not certified on the particular product or asset in the territory. Other constraints include Call Activity Time (CAT) 1013 and Travel Time (TT) 1014. Call activity time is the amount of time spent by a technician on servicing an asset. The default CAT is, for example, 145 hours. The default TT is, for example, 30 minutes. That is, the standard time for a technician to travel to an asset within a territory is expected to be about one half hour. Subsets of the travel time constraints include tolerances for geographies and technician skill levels. A rural tolerance 1015 provides a numeric entry box for a technician to drive beyond the assigned travel time. In the example system described herein, a greater tolerance for rural areas is assumed due to the larger geographic areas covered by those technician in rural territories. A metro tolerance 1016 similarly provides a numeric entry box for a technician to drive beyond the assigned travel time. In the system described herein, a small tolerance is assumed as the driving is expected to be inter-city. A technician tolerance 1017 provides specific and separate drive timer tolerances at the individual technician level. The technician tolerance 1017 is useful for addressing the technical or other areas of expertise of the individual technicians such as, for example, color expertise, networking expertise, etc.

Once all the territories 1006, 1008 are selected, and all the constraints 1010 are validated, the user 102 initiates the auto-alignment function 800 (FIG. 8) wherein a one of the plurality of geo-service application systems 150 is called at 1020 for assisting the system in providing a polygon for each selected area or territory. Thereafter, at 1030, the plurality of geo-service application systems 150 are used once again for calculating and returning bounding boxes for all the included territories. In the example illustrated, there are only two territories 1006, 1008 but as would be appreciated, the system can be used with more than two territories. A center point of each bounding box is determined at 1040 by an appropriate call to a selected one of the geo-service application systems 150. As well, at 1040, the system determines a radius for each territory based upon the polygon determined at 1030.

Optionally, the system may recalculate the radius determined as noted above based on the tolerance data values set by the user such as, for example, the travel time tolerance for rural territories, city territories, or the like. For example, if the travel time tolerance is set to 15 miles, the radius returned form the relevant geo-service application systems 150 may be expanded by the 15 miles of the tolerance.

An identification of boundaries between adjacent territories 1006 and 1008 is made at 1050 and a boundary 1007 therebetween is created. In the example embodiment, only a single boundary line 1007 is created as there are only two territories shown. However, it is to be appreciated that the system creates boundaries between each of the adjacent territories selected by the user. No calculations are made by the system, however, for boundaries on bounding box sides where there are no adjacent territories.

At 1060, a corridor 1061 is established relative to all of the adjacent territories. In the example shown, a single corridor 1061 is created by a selected one of the geo-service application systems 150 between the pair of adjacent territories 1006, 1008. The tolerances 1014-1017 are once again applied at 1070 to the relevant territories and all assets within the modified boundaries are identified at 1072.

Automatic territory alignment is performed by the system in general as shown at 1080, wherein at 1081 a reference that includes a call activity time for all assets within the territories is built using a suitable geo-service application system 150. The references are stored in the memory 114 such as, for example, in one or more databases. Further, a reference of all assets in the boundary areas of each of the territory's geographic boundaries is built for use in territory alignment processing. At 1082, assets are added to the territories 1006, 1008 until a target call activity time is achieved for the relevant territory. Each asset added into the territory adds an incremental and specific call activity time and each territory is associated by the user with a maximum overall call activity time threshold value. The threshold value may be determined beforehand and stored in the system memory 114. In addition, the threshold value may be a selected single value or it may be a selected band or range of values as necessary or desired, determined beforehand and stored in the system memory 114.

For territory alignment, in general, if the current call activity time of a territory is within a desired call activity time threshold band, the territory is not targeted for any increases of machines in the field (MIF). However, if the current call activity time of a territory is below a lower limit of the desired call activity time threshold band, the territory is targeted for an increase of assets or machines in the field (MIF). Similarly, if the current call activity time of a territory is above an upper limit of the desired call activity time threshold band, the territory is targeted for a decrease of assets or machines in the field (MIF). Although call activity is used as the target parameter or metric, other parameters, values, characteristics or aspects of the system, territories, or of assets within the territories may be used for automatic territory alignment as well.

Processing for automatic territory alignment in the example embodiment in general seeks to balance the call activity times of the territories. Territory call activity time balancing moves assets from those territories over a call activity standard, to those adjacent territories that are below the call activity standard. The assignment of the corridor territories 1061 is especially useful in the example embodiment. More particularly, in the example embodiment, if the overall target territory call activity time is lower than a predetermined standard CAT measure, then the target call activity time is calculated by subtracting the territory CAT from the standard CAT. Assets within the corridor territory are selected and their Cat is accumulated in to the relevant territory absorbing the asset. Other corridor assets are iteratively selected and their respective CAT values are accumulated until the CAT standard is reached for the relevant territory.

In the example embodiment, the system maintains a record in the memory 114 of those territories where corridor territory assets are assigned and, further, the system does not permit the CAT values of these territories to fall below the CAT threshold in the asset reassignment calculation and processing operations. If a territory reaches the CAT threshold by assigning assets to other territories, then no more of the territory's assets are assigned to other territories during the automatic territory alignment processing.

In the example embodiment, revised territories 1006′, 1008′ are determined by the system using the above-described automatic territory alignment method. A desired goal of the system in the example is to ensure by the automatic territory adjustment processing that the CAT of each territory should not vary by more that about 30% from the desired CAT value. It is to be appreciated, however, that although call activity time is used as the measured parameter, other parameters may be used for automatic territory alignment equivalently as necessary or desired. FIGS. 11a and 11b provide an illustration of a numeric example automatic territory alignment wherein the first and second territories 406, 408 are adjusted or realigned by the system 100 using the methods described above to realize revised territories 1006′, 1008′. In the example, a standard call activity time is assumed to be CAT=135 and an ideal call activity time is assumed to be CAT=270. The call activity time for the first territory 1006 is calculated to be CAT=205 and the call activity time for the second territory 1008 is calculated to be CAT=104. Thus the overall call activity time for the areas of coverage including both original territories 1006, 1008 is CAT=205+104=309. Since the overall call activity time for the gross service area is above the ideal call activity time defined by the user, the system determines that one of the territories has a call activity time which is over the standard. Accordingly, in order to reduce the CAT value for the first territory 1006, assets within the corridor 1061 are selectively reassigned to the second territory 1008. As shown in FIG. 11b, the reassignment of the selected assets of the second territory 1008 and within the corridor 1061 effectively shrinks the geographical extent of the first territory 1006 and expands the geographical extent of the second territory 1008 by about an amount of territory represented by the corridor box 1061.

By use of the above sequence iteratively on two or more territories at 1080 (FIG. 10), the system generates a set of balanced territories and machines in the field at 1090 for presentation to the user as a set of automatically realigned territories.

The example embodiments extend to computer programs stored in a memory in the form of source code, object code, code intermediate sources and object code (such as in a partially compiled form), or in any other form suitable for use in the implementation of the embodiments such, as for example, one or more logic devices. Computer programs are suitably standalone applications, software components, scripts or plug-ins to other applications. Computer programs embedding the embodiments are advantageously embodied on a physical carrier, being any entity or device capable of carrying the computer program: for example, a storage medium such as ROM or RAM, optical recording media such as CD-ROM or magnetic recording media such as floppy discs. Computer programs are suitably downloaded across the Internet or other network from a server. Computer programs are also capable of being embedded in an integrated circuit or any other form of logic. Any and all such embodiments containing code that will cause a computer to perform substantially the principles as described, will fall within the scope of this disclosure.

The foregoing description of the preferred embodiments has been presented for purposes of illustration and description. It is not intended to be exhaustive or to limit the embodiments to the precise form disclosed. Obvious modifications or variations are possible in light of the above teachings. The embodiments were chosen and described to provide the best illustration of the principles of the subject system and method and its practical application to thereby enable one of ordinary skill in the art to use the embodiments in various embodiments and with various modifications as are suited to the particular use contemplated. All such modifications and variations are within the scope of this disclosure as determined by the appended claims when interpreted in accordance with the breadth to which they are fairly, legally and equitably entitled.

What is claimed is:

1. A territory management method executed by a territory management system including a processor, a memory, and a display for managing delivery of services by a plurality of service technicians to a plurality of assets within a plurality of user defined territories, the method comprising:
selecting a plurality of service territories;
retrieving for each of a first set of assets associated with a first service territory and a second set of assets associated with a second service territory, asset data including geocode data representative of geographic locations of each of the assets of the first and second sets of assets;
storing constraint parameter data representative of user selected constraints in the memory;
storing threshold parameter data representative of user selected thresholds in the memory;
applying, by the processor, the constraint parameter data to the asset data;
performing, by the processor, a comparison between the asset data constrained by the constraint parameter data relative to the threshold parameter data; and,
displaying on the display a result of the comparison.

2. The territory management method according to claim 1, wherein:
the selecting a plurality of service territories includes selecting, by the processor, a corridor territory between adjacent first and second territories;
the determining includes determining by the processor a first comparison between first asset data of a first set of assets located in the first territory constrained by the constraint parameter data relative to the threshold parameter data, a second comparison between second asset data of second set of assets located in the second territory constrained by the constraint parameter data relative to the threshold parameter data, and a third comparison between corridor territory asset data of third set of assets located in the corridor territory constrained by the constraint parameter data relative to the threshold parameter data; and,
the displaying includes displaying on the display the results of the first, second and third comparisons.

3. The territory management method according to claim 2 further including:
storing in the memory virtual boundary data representative of virtual boundaries of the plurality of territories;
storing, in the memory, geographic boundary data corresponding to the virtual boundary data and representative of geographic boundaries of the plurality of territories;
storing, in the memory, virtual corridor area data representative of a virtual corridor area between at least two immediately adjacent first and second territories;
storing, in the memory, geographical corridor area data corresponding to the virtual corridor area data and representative of a geographical corridor area between the at least two immediately adjacent first and second territories;
accessing a database in the memory for retrieving for each of a first set of assets associated with the first territory and a second set of assets associated with the second territory, geocode data representative of geographic locations of each of the assets of the first and second sets of assets;
for each asset of the first and second sets of assets, determining, by the processor, an asset score data in accordance with the constraint parameter data and the geocode data of the asset;
determining, by the processor, a first overall asset score of the first set of assets;
determining, by the processor, a second overall asset score of the second set of assets;
determining, by the processor, a corridor area asset score of ones of the first and second sets of assets located in the geographical corridor area; and,
displaying, on the display, the corridor asset score and the first and second overall asset scores relative to the threshold parameter data.

4. The territory management method according to claim 3, wherein the storing the virtual boundary data includes:
receiving an input from a user of the system defining the virtual boundaries of the plurality of virtual boundaries;
displaying the user defined virtual boundaries on the display; and,
generating the virtual boundary data in accordance with the user defined virtual boundaries.

5. The territory management method according to claim 4 wherein the storing the geographic boundary data includes:
accessing an associated data acquisition system operatively coupled with the territory management system;
providing the associated data acquisition system with information relating to at least the first and second territories of the plurality of territories; and,
receiving the geographic boundary data by the territory management system of at least the first and second territories of the plurality of territories from the associated data acquisition system.

6. The territory management method according to claim 3, wherein the storing the virtual corridor data includes:
retrieving user-selected corridor parameter data from the memory;
receiving a first input representative of a selection of the first territory;
receiving a second input representative of a selection of the second territory immediately adjacent the first territory;
determining by the processor a substantially rectangular corridor boundary area between the first and second territories; and,
generating by the processor the virtual corridor data in accordance with the user-selected parameter data and the determined substantially rectangular corridor boundary area.

7. The territory management method according to claim 3, further including:
receiving a territory asset adjustment signal from the user of the system;
modifying the first and second territories responsive to the territory asset adjustment signal by:
selectively reassigning ones of the first set of assets in the corridor area to the second territory in accordance with a first result of a comparing of the first and second overall asset scores with the threshold parameter; and,
selectively reassigning ones of the second set of assets in the corridor to the first territory in accordance with a second result of a comparing of the first and second overall asset scores with the threshold parameter.

8. The territory management method according to claim 7, wherein the storing the constraint parameter data includes storing:
data corresponding to a drive time of associated service personnel to the assets in the first and second territories;
data corresponding to a call activity time related to time required for servicing the assets in the first and second territories by the associated service personnel; and
data corresponding to volume production of the assets in the first and second territories.

9. A territory management system for managing delivery of services by a plurality of service technicians to a plurality of assets within a plurality of user defined territories, the system comprising:
means adapted for selecting a plurality of service territories;
means adapted for retrieving for each of a first set of assets associated with a first service territory and a second set of assets associated with a second service territory, asset data including geocode data representative of geographic locations of each of the assets of the first and second sets of assets;
means adapted for storing constraint parameter data representative of user selected constraints;
means adapted for storing threshold parameter data representative of user selected thresholds;
means adapted for applying the constraint parameter data to the asset data;
means adapted for determining a comparison between the asset data constrained by the constraint parameter data relative to the threshold parameter data; and,
means adapted for displaying a result of the comparison.

10. The territory management system according to claim 9, wherein:
the means for selecting includes means for selecting a corridor territory between adjacent first and second territories;
the means for determining includes means for determining a first comparison between first asset data of a first set of assets located in the first territory constrained by the constraint parameter data relative to the threshold parameter data, a second comparison between second asset data of second set of assets located in the second territory constrained by the constraint parameter data relative to the threshold parameter data, and a third comparison between corridor territory asset data of third set of assets located in the corridor territory constrained by the constraint parameter data relative to the threshold parameter data; and,
the means for displaying includes means for displaying the results of the first, second and third comparisons.

11. The territory management system according to claim 10, further including:
means for storing virtual boundary data representative of virtual boundaries of the plurality of territories;
means for storing geographic boundary data corresponding to the virtual boundary data and representative of geographic boundaries of the plurality of territories;
means for storing virtual corridor area data representative of a virtual corridor area between at least two immediately adjacent first and second territories;
means for storing geographical corridor area data corresponding to the virtual corridor area data and representative of a geographical corridor area between the at least two immediately adjacent first and second territories;
means for accessing a database in the memory for retrieving for each of a first set of assets associated with the first territory and a second set of assets associated with the second territory, geocode data representative of geographic locations of each of the assets of the first and second sets of assets;
means for determining, for each asset of the first and second sets of assets, an asset score data in accordance with the constraint parameter data and the geocode data of the asset;
means for determining a first overall asset score of the first set of assets;
means for determining a second overall asset score of the second set of assets;
means for determining a corridor area asset score of ones of the first and second sets of assets located in the geographical corridor area; and,
means for displaying the corridor asset score and the first and second overall asset scores relative to the threshold parameter data.

12. The territory management system according to claim 11, wherein the means for storing the virtual boundary data includes:
means for receiving an input from a user of the system defining the virtual boundaries of the plurality of virtual boundaries;
means for displaying the user defined virtual boundaries on a display; and,
means for generating the virtual boundary data in accordance with the user defined virtual boundaries.

13. The territory management system according to claim 12 wherein the means for storing the geographic boundary data includes:
means for accessing an associated data acquisition system operatively coupled with the territory management system;
means for providing the associated data acquisition system with information relating to at least the first and second territories of the plurality of territories; and,
means for receiving the geographic boundary data by the territory management system of at least the first and second territories of the plurality of territories from the associated data acquisition system.

14. The territory management system according to claim 11, wherein the means for storing the virtual corridor data includes:
means for retrieving user-selected corridor parameter data from a memory;
means for receiving a first input representative of a selection of the first territory;
means for receiving a second input representative of a selection of the second territory immediately adjacent the first territory;
means for determining by the processor a substantially rectangular corridor boundary area between the first and second territories; and,
means for generating by a processor the virtual corridor data in accordance with the user-selected parameter data and the determined substantially rectangular corridor boundary area.

15. The territory management system according to claim 11, further including:
means for receiving a territory asset adjustment signal from the user of the system;
means for modifying the first and second territories responsive to the territory asset adjustment signal by:
means for selectively reassigning ones of the first set of assets in the corridor area to the second territory in accordance with a first result of a comparing of the first and second overall asset scores with the threshold parameter; and,
means for selectively reassigning ones of the second set of assets in the corridor to the first territory in accordance with a second result of a comparing of the first and second overall asset scores with the threshold parameter.

16. The territory management system according to claim 11, wherein the means for storing the constraint parameter data includes:
means for storing data corresponding to a drive time of associated service personnel to the assets in the first and second territories;
means for storing data corresponding to a call activity time related to time required for servicing the assets in the first and second territories by the associated service personnel; and
means for storing data corresponding to volume production of the assets in the first and second territories.

17. An apparatus for managing delivery of services by a plurality of service technicians to a plurality of assets within N user defined territories, where N is an integer greater than or equal to 2, the apparatus comprising:
a service territory selector configured to select N service territories, where N is an integer greater than or equal to 2;
a geo-code data retrieval portion configured to retrieve for each of 1^{st}-N^{th} sets of assets associated with the 1^{st}-N^{th} territories, asset data including geocode data representative of geographic locations of each of the assets of the 1^{st}-N^{th} sets of assets;
a constraint selector configured to store constraint parameter data representative of user selected constraints;
a threshold data selector configured to store threshold parameter data representative of user selected thresholds;
a constraint processor configured to apply the constraint parameter data to the asset data;
a comparator configured to determine a comparison between the asset data constrained by the constraint parameter data relative to the threshold parameter data; and,
a display configured to display a result of the comparison.

18. The territory management system according to claim 17, wherein:
the service territory selector is configured to select a set of corridor territories between adjacent territories of the 1^{st}-N^{th} territories;
the comparator is configured to determine, for each corridor territory of the set of corridor territories, a first comparison between first asset data of a first set of assets located in a first territory constrained by the constraint parameter data relative to the threshold parameter data, a second comparison between second asset data of second set of assets located in a second territory adjacent the first territory constrained by the constraint parameter data relative to the threshold parameter data, and a third comparison between corridor territory asset data of a third set of assets located in a corridor territory between the first and second territories constrained by the constraint parameter data relative to the threshold parameter data; and,
the display is configured to display, for each corridor territory of the set of corridor territories, the results of the first, second and third comparisons.

19. The territory management system according to claim 18, further including:
a memory for storing virtual boundary data representative of virtual boundaries of the plurality of territories;
a memory for storing geographic boundary data corresponding to the virtual boundary data and representative of geographic boundaries of the plurality of territories;
a memory for storing virtual corridor area data representative of a virtual corridor area between at least two immediately adjacent first and second territories;
a memory for storing geographical corridor area data corresponding to the virtual corridor area data and representative of a geographical corridor area between the at least two immediately adjacent first and second territories;
a processor configured to access a database for retrieving for each of a first set of assets associated with the first territory and a second set of assets associated with the second territory, geocode data representative of geographic locations of each of the assets of the first and second sets of assets;
the processor being configured to determine, for each asset of the first and second sets of assets, an asset score data in accordance with the constraint parameter data and the geocode data of the asset;
the processor being configured to determine a first overall asset score of the first set of assets;
the processor being configured to determine a second overall asset score of the second set of assets;
the processor being configured to determine a corridor area asset score of ones of the first and second sets of assets located in the geographical corridor area; and,
the display is configured to display the corridor asset score and the first and second overall asset scores relative to the threshold parameter data.

20. The territory management system according to claim 19, wherein the means for storing the virtual boundary data includes:
means for receiving an input from a user of the system defining the virtual boundaries of the plurality of virtual boundaries;
means for displaying the user defined virtual boundaries on a display; and,
means for generating the virtual boundary data in accordance with the user defined virtual boundaries.
